(19) United States
(12) Patent Application Publication
(10) Pub. No.: US 2019/0359483 A1
(43) Pub. Date: Nov. 28, 2019

(54) HYDROGEN STORAGE AND DELIVERY MATERIAL

(71) Applicant: University of Technology Sydney, Ultimo, New South Wales (AU)

(72) Inventors: Zhenguo HUANG, Ultimo, New South Wales (AU); Jian HONG, Ultimo, New South Wales (AU); Hua Kun LIU, Ultimo, New South Wales (AU); Zaiping GUO, Ultimo, New South Wales (AU)

(21) Appl. No.: 16/470,060

(22) PCT Filed: Dec. 15, 2017
(86) PCT No.: PCT/AU2017/051397

§ 371 Date: Jun. 14, 2019

(30) Foreign Application Priority Data
Dec. 15, 2016 (AU) 2016905200

(51) Int. Cl. C01B 3/00; H01M 8/04082; C07F 5/02

(52) U.S. Cl. CPC C01B 3/0015; C07F 5/027; H01M 8/04216

(57) ABSTRACT

The present invention provides novel diamine-monoborane liquid organic hydrogen carriers with hydrogen storage capacities at least equivalent to prior art hydrogen carriers. The novel diamine-monoboranes of the invention provide advantages over the prior art including low cost due to the simple one-step chemical synthesis method between a diamine and a borane complex, and that the starting materials are inexpensive compared to the prior art. The novel diamine-monoboranes of the invention provide excellent dehydrogenation performance. With the presence of inexpensive and readily-available commercial catalysts, dehydrogenation occurs at ambient temperatures and pressures with high hydrogen purity. The resulting 1,3,2-diazaborolidines (cyclic diaminoboranes) are readily hydrogenated to produce the novel diamine-monoboranes of the invention. The invention also provides use of the diamine-monoboranes of the invention in a fuel cell or a portable power cell, or cell installed in conjunction with a hydrogen-burning engine. Other uses relate to transport down pipelines and in tankers.

This application claims priority to and the benefit of Australian provisional patent application no. 2016905200 dated 15 Dec. 2016, which is incorporated herein by cross-reference in its entirety.

### FIELD OF THE INVENTION

The present invention relates to hydrogen storage materials and more specifically to hydrogen storage materials based on mono-boranes, and in particular diaminemonoboranes, and will be described hereinafter with reference to this application. However, it will be appreciated that the invention is not limited to this particular field of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

In the past, considerable attention has been given to the use of hydrogen as a fuel or fuel supplement. While the world's oil reserves are being rapidly depleted, the supply of hydrogen remains virtually unlimited. Hydrogen can be produced from coal, natural gas and other hydrocarbons, or formed by the electrolysis of water. Moreover hydrogen can be produced without the use of fossil fuels, such as by the electrolysis of water using nuclear or solar energy. Furthermore, hydrogen, although presently more expensive than petroleum, is a relatively low cost fuel. Hydrogen has the highest density of energy per unit weight of any chemical fuel and is essentially non-polluting since the main by-product of burning hydrogen is water.

Many of the major car manufacturers have commercialized hydrogen fuel cell cars, which are quick to refill, in the order of a few minutes compared to several hours required for electric vehicles, and have a driving range which is comparable to conventional cars (500 km in contrast to 100-200 km for electric cars). So far, the hurdle for a wide deployment of these cars is lack of efficient means for hydrogen storage and delivery. As discussed below, there are many disadvantages of conventional compressed and liquefied hydrogen. However, hydrogen stored by liquid media is highly compatible with existing liquid delivery and fuel injection techniques, and therefore could be quickly adopted by the market. In addition, hydrogen is an ideal candidate to store energy produced by renewable resources such as wind and solar. If adopted by energy companies for large-scale energy storage and delivery, liquid-based hydrogen carriers could be potentially revolutionary in the marketplace.

While hydrogen has wide potential application as a fuel, a major drawback in its utilization, especially in mobile uses such as the powering of vehicles, has been the lack of an acceptable lightweight hydrogen storage medium. Conventionally, hydrogen has been stored in a pressure-resistant vessel under a high pressure or stored as a cryogenic liquid, being cooled to an extremely low temperature. Storage of hydrogen as a compressed gas involves the use of large and heavy vessels. In a steel vessel or tank of common design only about 1% of the total weight is comprised of hydrogen gas when it is stored in the tank at a typical pressure of 136 atmospheres. In order to obtain equivalent amounts of energy, a container of hydrogen gas weighs about thirty times the weight of a container of gasoline/petroleum.

Additionally, transfer is very difficult, since the hydrogen is stored in a large-sized vessel, and the amount of hydrogen stored in a vessel is limited, due to low density of hydrogen. Furthermore, storage as a liquid presents a serious safety problem when used as a fuel for motor vehicles since hydrogen is extremely flammable. Liquid hydrogen also must be kept extremely cold, below ˜253° C., and is highly volatile if spilled. Moreover, liquid hydrogen is expensive to produce and the energy necessary for the liquefaction process is a major fraction of the energy that can be generated by burning the hydrogen.

Alternatively, certain metals and alloys have been known to permit reversible storage and release of hydrogen. In this regard, they have been considered as a superior hydrogen-storage material, due to their high hydrogen-storage efficiency. Storage of hydrogen as a solid hydride can provide a greater volumetric storage density than storage as a compressed gas or a liquid in pressure tanks. Also, hydrogen storage in a solid hydride presents fewer safety problems than those caused by hydrogen stored in containers as a gas or a liquid. Solid-phase metal or alloy system can store large amounts of hydrogen by absorbing hydrogen with a high density and by forming a metal hydride under a specific temperature/pressure or electrochemical conditions, and hydrogen can be released by changing these conditions. A desirable hydrogen storage material should preferably have a high storage capacity relative to the weight of the material, a suitable desorption temperature/pressure, good kinetics, good reversibility, resistance to poisoning by contaminants including those present in the hydrogen gas and be of a relatively low cost. If the material fails to possess one or more of these characteristics it is unlikely to be acceptable for wide-scale commercial utilization.

Further, the hydrogen storage capacity per unit weight of material is an important consideration in many applications, particularly where the hydride does not remain stationary. For vehicular applications, a low hydrogen storage capacity relative to the weight of the material reduces the mileage and hence the range of a vehicle. A low desorption temperature is desirable to reduce the amount of energy required to release the hydrogen. Furthermore, a relatively low desorption temperature to release the stored hydrogen is necessary for efficient utilization of the available exhaust heat from vehicles, machinery, or other similar equipment.

Further still, good reversibility is needed to enable the hydrogen storage material to be capable of repeated absorption-desorption cycles without significant loss of its hydrogen storage capabilities. Good kinetics is necessary to enable hydrogen to be absorbed or desorbed in a relatively short period of time. Resistance to contaminants to which the material may be subjected during manufacturing and utilization is required to prevent a degradation of acceptable performance.

The prior art hydrogen storage materials include a variety of metallic materials for hydrogen-storage, e.g., Mg, Mg—Ni, Mg—Cu, Ti—Fe, Ti—Ni, Mm-Ni and Mm-Co alloy systems (wherein, Mm is Misch metal, which is a rare-earth metal or combination/alloy of rare-earth metals). None of these prior art materials, however, has had all of the required properties required for a storage medium with widespread commercial utilization.

Of these materials, the Mg alloy systems can store relatively large amounts of hydrogen per unit weight of the storage material. However, heat energy must be supplied to release the hydrogen stored in the alloy, because of its low hydrogen dissociation equilibrium pressure at room temperature. Moreover, release of hydrogen can be made, only at a high temperature of over 250° C. along with the consumption of large amounts of energy.

The rare-earth (Misch metal) alloys have their own problems. Although they typically can efficiently absorb and release hydrogen at room temperature, based on the fact that it has a hydrogen dissociation equilibrium pressure on the order of several atmospheres at room temperature, their hydrogen-storage capacity per unit weight is lower than any other hydrogen-storage material and they are very expensive.

The Ti—Fe alloy system that has been considered as a typical and superior material of the titanium alloy systems, has the advantages that it is relatively inexpensive and the hydrogen dissociation equilibrium pressure of hydrogen is several atmospheres at room temperature. However, since it requires a high temperature of about 350° C. and a high pressure of over 30 atmospheres for initial hydrogenation, the alloy system provides relatively low hydrogen absorption/desorption rate. Also, it has a hysteresis problem which hinders the complete release of hydrogen stored therein.

Under the circumstances, a variety of approaches have been attempted to solve the problems of the prior art and to develop an improved material which has a high hydrogen-storage efficiency, a proper hydrogen dissociation equilibrium pressure and a high absorption/desorption rate. In this regard, Ti—Mn alloy system has been reported to have a high hydrogen-storage efficiency and a proper hydrogen dissociation equilibrium pressure, since it has a high affinity for hydrogen and low atomic weight to allow large amounts of hydrogen-storage per unit weight. These alloy systems, however, still suffer many disadvantages described above.

Two kinds of hydrogen storage liquids have been studied in the past, in the form of organic and aqueous solutions. Water-mediated delivery relies on the hydrolysis of the active compound, often under catalytically controlled conditions without heating. The system setup is relatively simple compared with the thermally driven solid-state reaction. For hydrolytic hydrogen release, boron-containing compounds such as NaBH₄ and NH₃BH₃ are the most studied. These compounds present their own disadvantages, however. For example, the low solubility of NaBH₄ requires a large amount of water, which lowers the hydrogen storage capacity to under 4.0 wt %. Further, the hydrolytic products tend to precipitate out of the system due to their poor solubility. Furthermore, a strong basic stabilizer is necessary to suppress the reaction between NaBH₄ and water. Yet further still, the solution is corrosive, which poses engineering challenges for practical systems.

Liquid organic hydrocarbons that evolve or release hydrogen upon heating have also been studied for over 60 years. Such liquid organic hydrogen carriers (LOHC) are hydrogenated for storage and dehydrogenated again when the energy/hydrogen is needed. However, they still lack the required properties, such as low melting point, high boiling point, adequate dehydrogenation kinetics, and low working temperatures. So far, the best candidate seems to be methylcyclohexane, which will dehydrogenate into toluene. Theoretically, methylcyclohexane has 6.1 wt % hydrogen and 47.4 kg H₂/m³, and both methylcyclohexane and toluene are liquid over a large temperature window. Efficient dehydrogenation, however, has to be carried out at high temperatures above 350° C. and requires high pressure of >0.3 MPa. Further, designing catalysts with high toluene selectivity and a moderate acidity to minimize coke formation has been challenging.

There is still a need in the art for a hydrogen storage material which provides one or more of the following properties: a high hydrogen-storage efficiency and capacity relative to the weight of the material, high absorption/desorption rate, good dissociation equilibrium pressure, be of a relatively low cost (starting materials and synthesis method), low desorption temperature/pressure to reduce the amount of energy required to release the hydrogen, good reversibility to enable the hydrogen storage material to be capable of repeated absorption-desorption cycles without significant loss of its hydrogen storage capabilities, good kinetics to enable hydrogen to be absorbed or desorbed in a relatively short period of time, resistance to poisoning by contaminants to which the material may be subjected during manufacturing and utilization (including those present in the hydrogen gas) to prevent a degradation of acceptable performance, have little or no hysteresis problems which will hinder the complete release of hydrogen stored therein, not undergo a phase change upon H₂ desorption, be a liquid under ambient conditions (e.g., at 20° C. and 1 atm pressure), be preferably air and moisture stable, be recyclable, and meets the current target for automobile applications (minimum of 5.5 wt % for the whole system including the hydrogen storage and delivery material, the container, associated fluid conduits, etc). At least some of these properties are required to ease the possible transition from a gasoline to a hydrogen infrastructure.

It is an object of the present invention to overcome or ameliorate one or more of the disadvantages of the prior art, or at least to provide a useful alternative.

### SUMMARY OF THE INVENTION

The present invention provides a new class of hydrogen storage materials based on carbon-boron-nitrogen (CBN) compounds that provide significant improvements over the liquid organic carriers of the prior art. The Applicant has determined that, instead of breaking strong C—H bonds to form hydrogen, dehydrogenation between B—H and N—H occurs under relatively mild conditions, which provides significant advantages in this new class of hydrogen storage materials. The new class of hydrogen storage materials disclosed herein comprise useful physical properties, such as melting point, volatility, and solubility, thereby providing promising materials to address at least some of the needs in the art discussed above. Surprisingly, the CBN-based hydrogen storage materials of the invention tend to avoid the production, in use, of insoluble long-chain polymers, which help maintain liquid phase throughout the dehydrogenation.

One boron-based prior art hydrogen storage material is BN-methylcyclopentane, which is an air- and moisture-stable liquid at room temperature (see US patent application No. 20130283675). It is capable of releasing 2 equivalents of H₂ per molecule, both thermally (above 150° C.), and catalytically using a variety of relatively inexpensive metal halides below 80° C. (FeCl₂ and NiCl₂) with the formation of a single dehydrogenation product that is also a liquid at room temperature. The waste heat from a fuel cell can be harvested to drive the reaction, which allows an efficient use of energy. BN-methylcyclopentane is a cyclic molecule and the decomposition product is predominantly trimer, which has a low melting point of ˜30° C. and is highly soluble in many solvents. The inventors of US 20130283675 have demonstrated the conversion of the dehydrogenated product back to the charged fuel with a 92% yield under relatively mild conditions. However, the material capacity (4.7 wt %) falls short of the current target for automobile applications (5.5 wt %, as discussed above). A further shortcoming of BN-methylcyclopentane is the synthesis, where toxic chemicals such as HF and pyridine are required. The present invention substantially ameliorates this issue, and provides an improved material capacity over BN-methylcyclopentane. For reference, the BN-methylcyclopentane dehydrogenation reaction can be seen in the following scheme.

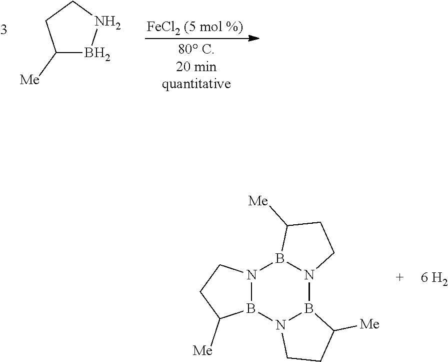

The present invention provides novel diamine-monoborane liquid organic hydrogen carriers with hydrogen storage capacities at least equivalent to prior art hydrogen carriers. The novel diamine-monoboranes of the invention provide advantages over the prior art including low cost due to: (a) the simple one-step chemical synthesis method between a diamine and a borane complex, and that (b) the starting materials are inexpensive. Additionally, the novel diamine-monoboranes of the invention provide excellent dehydrogenation performance. With the presence of inexpensive and readily-available catalysts, dehydrogenation occurs at ambient temperatures and pressures with high hydrogen purity. Suitable catalysts may be selected from: CoCl₂, CuCl₂, NiCl₂, FeCl₃ and FeCl₂.

An illustration of the hydrogenation and dehydrogenation mechanism of some preferred embodiments of the novel diamine-monoboranes (Formula I) of the invention can be seen in the following Scheme I. In some preferred embodiments, R¹ and R² in Formula I may be individually selected from the group consisting of H, and C₁-C₆ alkyl. In other embodiments, R¹ and R² in Formula I are individually selected from H, C₁-C₆ alkyl, C₁-C₆ alkoxy, NH₂, cyano (CN), or halogen. In a further embodiment, R¹ and R² in Formula I are both H.

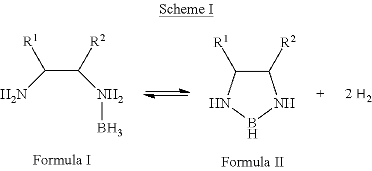

It will be appreciated that the diamine-monoboranes of the invention (Formula I) are fully saturated, i.e. fully charged, and the resulting 1,3,2-diazaborolidines (cyclic diaminoboranes) (Formula II) are dehydrogenated. As shown, the dehydrogenation reaction in Scheme I produces up to 2 moles of dihydrogen per mole of compound of Formula I.

It will be appreciated that further dehydrogenation of the compounds of Formula I (and analogously, compounds of Formula V and the cyclic dehydrogenation products formed from compounds of Formula III disclosed herein) may be achieved under appropriate conditions. For example, one or more dehydrogenated compounds such as those depicted in Formulae IIa, IIb, IIc, IId, or IIe may be formed from compounds of Formula II, with evolution of up to two additional moles of H₂:

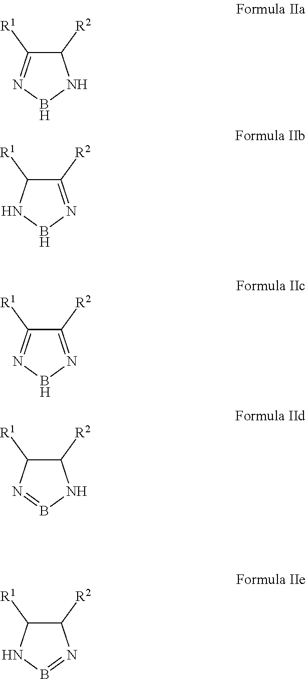

In some cases, the dehydrogenation products in Formulae IIa-e may require higher dehydrogenation temperatures than those needed to form the compound of Formula II from Formula I, and may require noble metal catalysts. Conditions for effecting dehydrogenations of this kind will be known to persons of skill in the art.

For the preferred compound of the invention, ethylenediamine monoborane (a compound of Formula I where R¹ and R²═H), the hydrogen capacity is over 5.4 wt %, which is a significant improvement over prior art compounds such as BN-methylcyclopentane. Ethylenediamine monoborane and the resulting 1,3,2-diazaborolidine product (produced after dehydrogenation) are both liquids at ambient temperatures and pressures, which provides significant advantages, as discussed above. NMR analysis of the dehydrogenated product (¹¹B NMR) indicates that the dehydrogenated product is predominantly cyclic 5-membered BCN compound, which is advantageous for regeneration, compared with ammonia borane that normally forms several undesirable compounds, including borazine, cyclodiborazane, polyborazylene.

According to a first aspect the present invention provides a compound having a structure represented by Formula III:

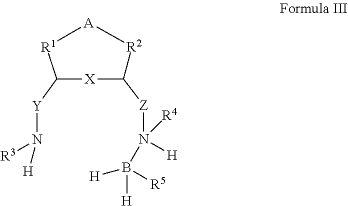

wherein if A is not present, each of R¹ and R² is individually selected from H, OH, C₁-C₆ alkyl, substituted C₁-C₆ alkyl, C₃₋₈ cycloalkyl, substituted C₃₋₈ cycloalkyl, C₁-C₆ alkoxy, substituted C₁-C₆ alkoxy, amino (NR⁶R⁷), cyano (CN), carbocyclylalkyl (including —(CH₂)ₙ-Ph wherein n=0-6), halogen, C₆₋₁₀ aryl or substituted C₆₋₁₀ aryl; or
if A is present, A is selected from —(CH₂)ₙ— wherein n=1-6; —O—, —C(═O)—, —S—, —S(═O)— or —CHR⁸—, and each of R¹ and R² is individually selected from bridging C₁-C₆ alkyl, bridging substituted C₁-C₆ alkyl, bridging C₁-C₆ alkoxy, bridging substituted C₁-C₆ alkoxy, bridging amino (NR⁶), bridging C₆₋₁₀ aryl or bridging substituted C₆₋₁₀ aryl; and
wherein each of R³ and R⁴ is individually selected from H, OH, a C₁-C₆ alkyl, cycloalkyl, haloalkyl, C₁-C₆ acyl, NH₂, CN, or SiR⁹;
wherein R⁵ is selected from H, C₁-C₆ alkyl, NH₂, CN, or OH;
wherein R⁶ and R⁷ are independently H, C₁-C₆ alkyl, or substituted C₁-C₆ alkyl;
wherein R⁸ is selected from C₁-C₆ alkyl, halogen, C₁-C₆ alkoxy, C₁-C₆ alkoxy-substituted C₁-C₆ alkyl, or amino (NR⁶R⁷);
wherein R⁹ is halogen, amino (NR⁶R⁷), alkoxy, or —(CH₂)-Ph wherein n=0-6; and
wherein X, Y and Z are independently selected from the group consisting of: —(CH₂)ₙ—
wherein n=0-6; —O—, —C(═O)—, —S—, —S(═O)— or —CHR⁸—.

In one embodiment, there is provided a compound of Formula IIIa,

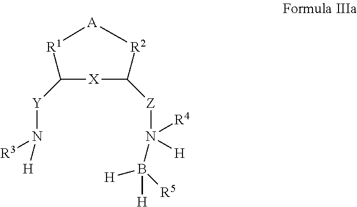

wherein if A is not present, each of R¹ and R² is individually selected from H, OH, C₁-C₆ alkyl, C₃₋₈ cycloalkyl, C₁-C₆ alkoxy, amino (NR⁶R⁷), cyano (CN), carbocyclylalkyl (including —(CH₂)ₙ-Ph wherein n=0-6), halogen, or C₆₋₁₀ aryl; or
if A is present, A is selected from —(CH₂)ₙ— wherein n=1-6; —O—, —C(═O)—, —S—, —S(═O)— or —CHR⁸—, and each of R¹ and R² is individually selected from bridging C₁-C₆ alkyl, bridging C₁-C₆ alkoxy, bridging amino (NR⁶), or bridging C₆₋₁₀ aryl; and
wherein each of R³ and R⁴ is individually selected from H, OH, a C₁-C₆ alkyl, cycloalkyl, haloalkyl, C₁-C₆ acyl, NH₂, CN, or SiR⁹;
wherein R⁵ is selected from H, C₁-C₆ alkyl, NH₂, CN, or OH;
wherein R⁶ and R⁷ are independently H or C₁-C₆ alkyl;
wherein R⁸ is selected from C₁-C₆ alkyl, halogen, C₁-C₆ alkoxy, C₁-C₆ alkoxy-substituted C₁-C₆ alkyl, or amino (NR⁶R⁷);
wherein R⁹ is halogen, amino (NR⁶R⁷), alkoxy, or —(CH₂)ₙ-Ph wherein n=0-6; and
wherein X, Y and Z are independently selected from the group consisting of: —(CH₂)ₙ—
wherein n=0-6; —O—, —C(═O)—, —S—, —S(═O)— or —CHR⁸—.

In another embodiment, there is provided a compound of Formula IIIb,

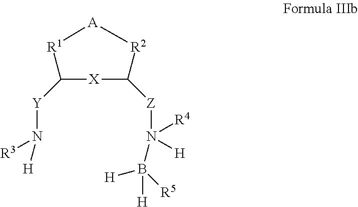

wherein A is not present, and each of R¹ and R² is individually selected from H, OH, C₁-C₆ alkyl, C₃₋₈ cycloalkyl, C₁-C₆ alkoxy, amino (NR⁶R⁷), cyano (CN), carbocyclylalkyl (including —(CH₂)ₙ-Ph wherein n=0-6), halogen, or C₆₋₁₀ aryl;
wherein each of R³ and R⁴ is individually selected from H, OH, a C₁-C₆ alkyl, cycloalkyl, haloalkyl, C₁-C₆ acyl, NH₂, CN, or SiR⁹;
wherein R⁵ is selected from H, C₁-C₆ alkyl, NH₂, CN, or OH;
wherein R⁶ and R⁷ are independently H or C₁-C₆ alkyl;
wherein R⁹ is halogen, amino (NR⁶R⁷), alkoxy, or —(CH₂)ₙ-Ph wherein n=0-6; and
wherein X, Y and Z are independently —(CH₂)ₙ— wherein n=0-6.

Formula IIIa represents an embodiment of Formula III, and Formula IIIb represents an embodiment of Formula IIIa. Accordingly, reference herein to compounds of Formula III in the methods according to the invention may be taken to include compounds of Formula IIIa and/or IIIb.

It will be appreciated that compounds of Formula III, IIIa and IIb as described above can produce up to 2 moles of dihydrogen per mole of compound when dehydrogenated in a manner analogous to Scheme I, due to the at least one hydrogen atom on each nitrogen, and the pair of hydrogen atoms on the boron.

In one embodiment, the present invention provides a compound having a structure represented by Formula IV:

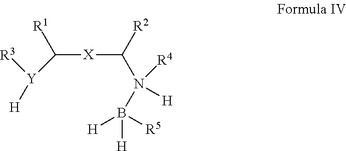

wherein each of R¹ and R² is individually selected from H, OH, C₁-C₆ alkyl, substituted C₁-C₆ alkyl, C₃₋₈ cycloalkyl, substituted C₃₋₈ cycloalkyl, C₁-C₆ alkoxy, substituted C₁-C₆ alkoxy, amino (NR⁶R⁷), cyano (CN), carbocyclylalkyl (including —(CH₂)ₙ-Ph wherein n=0-6), halogen, C₆₋₁₀ aryl or substituted C₆₋₁₀ aryl;
wherein each of R³ and R⁴ is individually selected from H, OH, C₁-C₆ alkyl, cycloalkyl, haloalkyl, C₁-C₆ acyl, NH₂, CN, or SiR⁹;
wherein R⁵ is selected from H, C₁-C₆ alkyl, NH₂, CN, or OH;
wherein R⁶ and R⁷ are independently H, C₁-C₆ alkyl, or substituted C₁-C₆ alkyl;
wherein R⁸ is selected from C₁-C₆ alkyl, halogen, C₁-C₆ alkoxy, C₁-C₆ alkoxy-substituted C₁-C₆ alkyl, or amino (NR⁶R⁷);
wherein R⁹ is halogen, amino, alkoxy, or —(CH₂)ₙ-Ph wherein n=0-6; and
wherein X is selected from the group consisting of: —(CH₂)ₙ— wherein n=0-6; —O—, —C(═O)—, —S—, —S(═O)— or —CHR⁸—.

In some embodiments, in Formula III, IIIa, IIIb or Formula IV, the substituted C₁-C₆ alkyl group is a C₁-C₆ alkoxy-substituted C₁-C₆ alkyl or a haloalkyl group. In some embodiments, the substituted C₃₋₈ cycloalkyl is a C₁-C₆ alkoxy-substituted C₃₋₈ cycloalkyl or is a C₃₋₈ cycloalkyl with one or more halogen substituents. In some embodiments, the substituted C₆₋₁₀ aryl is a C₁-C₆ alkoxy-substituted C₆₋₁₀ aryl, a C₁-C₆ alkyl-substituted C₆₋₁₀ aryl or a C₆₋₁₀ aryl group with one or more halogen substituents.

In another embodiment, the present invention provides a compound having a structure represented by Formula IVa:

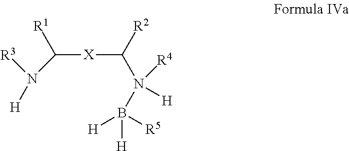

wherein each of R¹ and R² is individually selected from H, OH, C₁-C₆ alkyl, C₃₋₈ cycloalkyl, C₁-C₆ alkoxy, amino (NR⁶R⁷), cyano (CN), carbocyclylalkyl (including —(CH₂)ₙ-Ph wherein n=0-6), halogen, or C₆₋₁₀ aryl;
wherein each of R³ and R⁴ is individually selected from H, OH, C₁-C₆ alkyl, cycloalkyl, haloalkyl, C₁-C₆ acyl, NH₂, CN, or SiR⁹;
wherein R⁵ is selected from H, C₁-C₆ alkyl, NH₂, CN, or OH;
wherein R⁶ and R⁷ are independently H or C₁-C₆ alkyl;
wherein R⁸ is selected from C₁-C₆ alkyl, halogen, C₁-C₆ alkoxy, C₁-C₆ alkoxy-substituted C₁-C₆ alkyl, or amino (NR⁶R⁷);
wherein R⁹ is halogen, amino, alkoxy, or —(CH₂)ₙ-Ph wherein n=0-6; and
wherein X is selected from the group consisting of: —(CH₂)ₙ— wherein n=0-6; —O—, —C(═O)—, —S—, —S(═O)— or —CHR⁸—.

Formula IVa represents an embodiment of Formula IV. Accordingly, reference herein to compounds of Formula IV in the methods according to the invention are taken to include compounds of Formula IVa.

In one embodiment, at least one of R¹ and R² in Formula III, IIIa, IIIb, IV or IVa is methyl or ethyl. In one embodiment, at least one of R³ and R⁴ in Formula III, IIIa, IIIb, IV or IVa is methyl or ethyl. In one embodiment, in Formula IV or IVa, X is —(CH₂)ₙ— wherein n=0. In another embodiment, R¹ is H. In a further embodiment, in Formula IV or IVa, R² is H. In yet a further embodiment, in Formula IV or IVa, R³ is H. In yet a further embodiment, in Formula IV or IVa, R⁴ is H. In still a further embodiment, in Formula IV or IVa, R⁵ is H. In some embodiments, in Formula IV or IVa, R³ and R⁴ are both H. In one embodiment, in Formula IV or IVa, R¹, R² and R⁵ are all H. In another embodiment, in Formula IV or IVa, R¹, R², R³, R⁴ and R⁵ are all H. In one preferred embodiment, in Formula IV or IVa, X is —(CH₂)ₙ— wherein n=0, and R¹, R², R³, R⁴ and R⁵ are all H.

It will be appreciated that in a preferred embodiment of the invention, R¹, R², R³, R⁴ and R⁵ in Formula III, IIIa, IIIb, IV or IVa are all H, but other embodiments of the invention have other moieties which substitute one or more of the hydrogens. It is preferable that all the available positions comprise a hydrogen atom in order to maximise the gravimetric hydrogen storage density. However, replacing one or more of the moieties, whilst reducing the gravimetric density, can provide and improve other properties such as melting point, hydrogenation/dehydrogenation kinetics and/or thermodynamics, or chemical stability.

In some embodiments interesting compounds of the invention are defined as per Formula III, IIIa, IIIb, IV or IVa with the proviso that the following compounds are excluded:

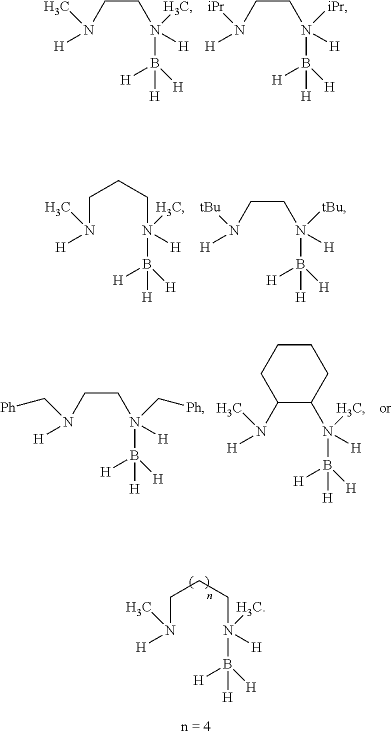

The dehydrogenation reaction of the compounds of Formula IV can be seen in the following Scheme II, whereby corresponding substituted 1,3,2-diazaborolidines (cyclic diaminoboranes) are produced (Formula V), and two moles of dihydrogen are produced. An analogous process applies to compounds of Formula III.

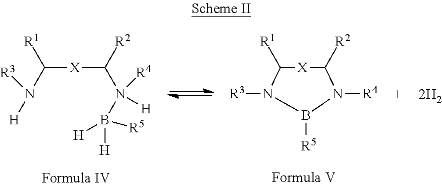

It will be appreciated that selection of the substituents R¹ to R⁵ and X in Formula IV and IVa, or selection of substituents R¹ to R⁵, X, Y, Z, and A in Formula III, IIIa and IIIb may be used to customize or fine-tune the chemical nature of the diamine-monoboranes of the invention. For example alkyl substitution may create substrates with enhanced organic solubilities, while charged side chains will result in more polar compounds. Additionally, the electron donating or withdrawing nature of a given substituent or substituents may influence the reactivity of a given substrate to hydrogenation, or the facility with which that substrate can be regenerated. It will be appreciated that the compounds of the first aspect are hydrogen storage compounds. Without wishing to be bound by theory, it is contemplated that steric effects provided by one or more of the substituents R¹ to R⁵ may affect the ability of the diamine-monoborane starting materials and/or resulting 1,3,2-diazaborolidines to crystallize, thereby providing some control over the ability of these materials to remain as liquids over a wide range of conditions.

According to a second aspect the present invention provides a method of preparing a diamine-monoborane compound, the method comprising the steps of reacting a compound according to Formula VI with BH₃ or any of its equivalents under suitable conditions to obtain a compound having a structure represented by the compound according to Formula Ill.

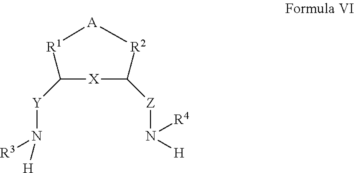

In one embodiment, the present invention provides a method of preparing a diamine-monoborane compound, the method comprising the steps of reacting a compound according to Formula VII with BH₃ or any of its equivalents under suitable conditions to obtain a compound having a structure represented by the compound according to Formula IV.

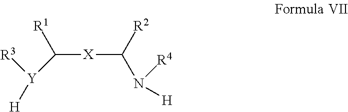

Preferably the equivalents to BH₃ are selected from the group consisting of: B₂H₆, BH₃.THF, BH₃.SMe₂, and disiamylborane. For example, the equivalent to BH₃ may be B₂H₆, BH₃.THF, BH₃.SMe₂, or disiamylborane. Preferably, the equivalent to BH₃ is BH₃.THF. Preferably, the reaction comprises 1 molar equivalent of a compound of Formula VI or VII and 1 molar equivalent of B₂H₆, BH₃.THF, BH₃.SMe₂, or disiamylborane. Preferably the reaction is conducted at room temperature for 24 hours. However, the skilled person will be familiar with suitable conditions in order to effect the reaction.

Also disclosed herein are methods for releasing hydrogen from any one of the above-described hydrogen storage compounds.

The present invention also provides a method for reversibly storing and releasing hydrogen, the method comprising the steps of:
a) providing a diamine-monoborane compound according to Formula III which is capable of reversible dehydrogenation and hydrogenation,
b) contacting the compound under reaction conditions sufficient to release gaseous hydrogen from the compound and produce an at least partially dehydrogenated 1,3,2-diazaborolidine, and
c) recovering the gaseous hydrogen.

The method may further comprise the steps of:
d) contacting the at least partially dehydrogenated 1,3,2-diazaborolidine under conditions to hydrogenate the dehydrogenated 1,3,2-diazaborolidine to produce a diamine-monoborane compound according to Formula III,
e) optionally recovering at least a portion of the heat produced from hydrogenation reaction of step d) and optionally using the recovered heat to provide at least part of the heat required for said hydrogen release of step b), and;
f) recovering the at least partially hydrogenated diamine-monoborane compound according to Formula IV.

Disclosed herein is a method comprising: releasing hydrogen from a hydrogen storage compound having a structure represented by Formula I or III under conditions sufficient to produce a 1,3,2-diazaborolidine. The method includes the step of hydrogenating the 1,3,2-diazaborolidine to obtain a structure represented by Formula I or Ill.

In one embodiment there is provided a method for reversibly storing and releasing hydrogen, the method comprising the steps of:
a) providing a diamine-monoborane compound according to Formula IV which is capable of reversible dehydrogenation and hydrogenation,
b) contacting the compound under reaction conditions sufficient to release gaseous hydrogen from the compound and produce an at least partially dehydrogenated 1,3,2-diazaborolidine, and
c) recovering the gaseous hydrogen.

In this embodiment, the method may further comprise the steps of:
d) contacting the at least partially dehydrogenated 1,3,2-diazaborolidine under conditions to hydrogenate the dehydrogenated 1,3,2-diazaborolidine to produce a diamine-monoborane compound according to Formula IV,
e) optionally recovering at least a portion of the heat produced from hydrogenation reaction of step d) and optionally using the recovered heat to provide at least part of the heat required for said hydrogen release of step b), and;
f) recovering the at least partially hydrogenated diamine-monoborane compound according to Formula IV.

Disclosed herein is a method comprising: releasing hydrogen from a hydrogen storage compound having a structure represented by Formula I or IV under conditions sufficient to produce a 1,3,2-diazaborolidine. The method includes the step of hydrogenating the 1,3,2-diazaborolidine to obtain a structure represented by Formula I or IV.

Also disclosed herein is a hydrogen storage method comprising: releasing hydrogen from at least one saturated diamine-monoborane composition as disclosed herein under conditions sufficient to produce a 1,3,2-diazaborolidine; and hydrogenating the 1,3,2-diazaborolidine.

In certain embodiments, the diamine-monoboranes of the invention have a melting point of less than 55° C., at 1 atmosphere, particularly less than 35° C., at 1 atmosphere, and more particularly less than 0° C., at 1 atmosphere, and most particularly less than −10° C., at 1 atmosphere. The diamine-monoboranes of the invention may be a liquid at ambient conditions (e.g., 20° C. at 1 atmosphere). The diamine-monoboranes of the invention may thus have a melting point of between about −10° C. and about 55° C., or between about −10 and 10° C., or 10 and 30° C., or 20 and 50° C., or of about −10, 0, 10, 20, 30, 40, or 50° C. at 1 atmosphere.

The diamine-monoboranes of the invention may have a gravimetric hydrogen capacity of between about 3 and 6 wt %, e.g., of between about 3 and 4, or 4 and 5, or 3.5 and 6, or 4 and 5.5 wt %. The diamine-monoboranes of the invention may have a hydrogen capacity at a gravimetric density of at least 4.0 wt %, more particularly at least 4.5 wt %. For example, the diamine-monoboranes of the invention may have a gravimetric hydrogen capacity of about 3, 3.5, 4, 4.5, 5, 5.5 or 6 wt %. The diamine-monoboranes of the invention may have a volumetric density of between about 30 and about 60 g H₂/L, for example, of between about 30 and 40, or between about 35 and 55, or between about 50 and 60 g H₂/L. For example, the diamine-monoboranes of the invention may have a volumetric density of at least 35 g H₂/L, more particularly at least 40 g H₂/L. In some embodiments, the diamine-monoboranes of the invention have a gravimetric hydrogen capacity of between about 3 and 6 wt % and a volumetric density of between about 30 and about 60 g H₂/L.

In certain embodiments, the diamine-monoboranes of the invention are relatively stable in air. In other embodiments, the diamine-monoboranes of the invention are recyclable (e.g., amenable to rehydrogenation). In yet other embodiments, the diamine-monoboranes of the invention release H₂ controllably and cleanly such that no significant by-product formation is observed, and preferably quantitatively (e.g., the yield of the desired product is greater than 98%) at temperatures below or at the PEM fuel cell waste heat temperature of 80° C. In yet further embodiments, the diamine-monoboranes of the invention utilize catalysts that are cheap and abundant for H₂ desorption. In still further embodiments, the diamine-monoboranes of the invention feature reasonable gravimetric and volumetric storage capacity. In still further embodiments, the diamine-monoboranes of the invention do not undergo a phase change upon H₂ desorption. In some embodiments, the diamine-monoboranes of the invention have two or more of the characteristics in this paragraph.

The diamine-monoboranes disclosed herein are useful as hydrogen storage materials. In further embodiments disclosed herein, there are provided methods for storing and/or releasing hydrogen from the diamine-monoborane compounds described herein. For example, disclosed herein are hydrogen storage methods that include releasing hydrogen from at least one saturated diamine-monoborane under conditions sufficient to produce a 1,3,2-diazaborolidine (cyclic diaminoborane), and optionally hydrogenating the 1,3,2-diazaborolidine (cyclic diaminoborane) to produce the saturated diamine-monoborane starting material. The hydrogen may be released and/or added during the hydrogen storage cycle in any form. For example, the hydrogen may be released and/or added as a formal equivalent of dihydrogen. A formal equivalent of dihydrogen is two hydrogen atoms, whether the hydrogen atoms are added to the substrate as dihydrogen (during hydrogenation), as hydride ions, or as protons. For example, the combination of a hydride ion and a proton formally constitutes one equivalent of dihydrogen.

The presently disclosed saturated diamine-monoboranes of the invention are well suited to acting as substrates for hydrogen storage. They possess well-defined molecular structures throughout the entire hydrogen storage lifecycle, they possess a high H₂ storage capacity, they exhibit an appropriate enthalpy of H₂ desorption that permits ready regeneration by H₂, and they are either liquids, or are capable of being dissolved in liquids under the desired operating conditions. In addition, the hydrogenation of the dehydrogenated product is readily reversible, regenerating the well-characterized original substrate.

A hydrogen storage cycle for an exemplary ethylenediamine monoborane compound is shown below in Scheme Ill. The cycle depicts the loss of up to 2 dihydrogen equivalents from the fully charged, i.e. reduced, compound. Treatment of the boron-nitrogen heterocycle with a digestion agent followed by a reducing agent regenerates the ethylenediamine monoborane compound. Other methods to regenerate the boron-nitrogen heterocycle will be known to the skilled person.

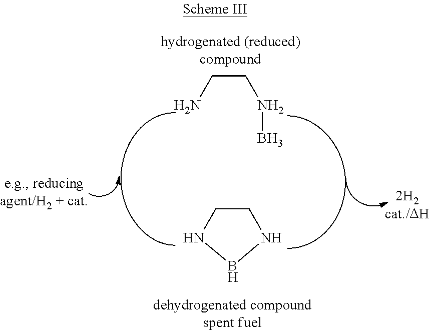

Release of hydrogen from the compounds disclosed herein may be accomplished by several approaches. For example, the compounds may be capable of releasing hydrogen both thermally and catalytically, or capable of releasing hydrogen thermally, or capable of releasing hydrogen catalytically. Thermal release includes heating the compound at a sufficiently high temperature to affect release of at least one dihydrogen equivalent. For instance, the compound may be heated at a temperature of at least 50° C., particularly below 150° C. Catalytic release of hydrogen includes contacting the compound with a metal halide catalyst at conditions sufficient for causing hydrogen release. A preferred compound is the ruthenium complex ([RuH₂(η²-H₂)₂(PCy₃)₂]) which is a good catalyst for forming cyclic compounds. The catalytic dehydrogenation optionally is conducted with heating such as at a temperature from 50 to 200° C., more particularly 50 to 80° C. The metal species of the metal halide catalyst may be selected, for example, from a transition metal, particularly a first-row transition metal. Illustrative metals include iron, cobalt, copper, nickel and illustrative halides include fluorine, chlorine, bromine, and iodine.

Preferably, dehydrogenation conditions are selected such that the compounds of the present invention dehydrogenate to produce between about 0.5 and 2 moles of dihydrogen per mole of compound, e.g., between about 0.5 and 1.5 moles H₂ per mole of compound, or between about 1 and 2 moles of H₂ per mole of compound, or about 2 moles of H₂ per mole of compound, or 1.8, 1.6, 1.4, 1.2, 1.0, 0.8, 0.6 or 0.5 moles of H₂ per mole of compound. Preferably, dehydrogenation of between about 0.5 and 2 moles of dihydrogen per mole of compound takes between about 5 and 20 minutes, or between 5 and 10 minutes, or between 10 and 20 minutes, e.g., 5, 7.5, 10, 12.5, 15, 17.5 or 20 minutes. The temperature at which dehydrogenation occurs is preferably set to between 20 and 100° C., e.g., to between 20 and 50, or 50 and 80, or 60 and 100, or 30 and 70° C., e.g., at 20, 30, 40, 50, 60, 70, 80, 90 or 100° C. The skilled person will appreciate that a combination of temperature and catalyst loading may be used to control the rate and/or extent of dehydrogenation of the compounds of the present invention.

The fully-dehydrogenated product is a cyclic diaminoborane (1,3,2-diazaborolidine). In certain embodiments, the cyclic diaminoborane has a structure shown in Formula V. In certain embodiments, the cyclic diaminoborane is a liquid at 20° C. at 1 atmosphere, and can remain in the liquid phase throughout the hydrogen storage cycle. For example, the cyclic diaminoborane may be a liquid at −10° C., 0° C., 10° C., 30° C., 40° C. or 50° C. at 1 atmosphere. In one embodiment, the cyclic diaminoborane is a colourless liquid at room temperature with a boiling point of around 80° C. at atmospheric pressure, and a freezing point below 0° C., in particular at around −20° C.

The dehydrogenated product(s) may be regenerated by hydrogenating (i.e., reducing) the dehydrogenated product(s). The dehydrogenated product(s) are also referred to herein as “spent fuel”. An illustrative regeneration embodiment is shown below in Scheme IV below. Scheme IV is shown for a 1,2-azaborine charged fuel compound 1, but this regeneration approach may also be applicable to the diamine-monoboranes of the invention. The dehydrogenated product(s) T is subjected to alkanolysis (e.g., methanolysis) to produce an intermediate. The intermediate then is reduced to the fully-charged fuel 1 by reaction with a reducing agent such as LiAlH₄, BH₃, or any other metal hydride MHₓ wherein M is an alkali or earth alkali metal or any transition metal and x can be any number of hydrogens.

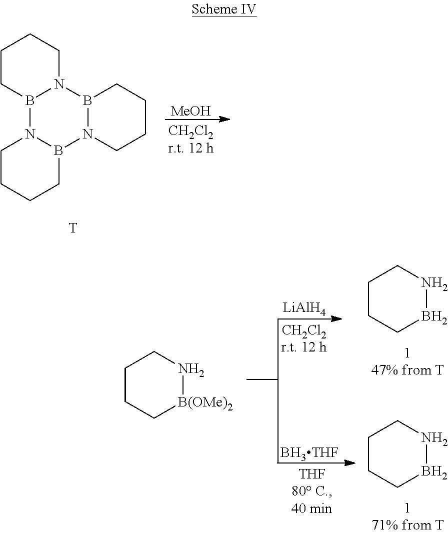

In other embodiments, the hydrogenation may occur in the presence of a hydrogenation catalyst. The hydrogenation catalyst may be a homogeneous catalyst or a heterogeneous catalyst. The hydrogenation catalyst may include one or more platinum group metals, including for example platinum, palladium, rhodium (such as Wilkinson's catalyst), ruthenium, iridium (such as Crabtree's catalyst), or nickel (such as Raney nickel or Urushibara nickel). Alternatively, or in addition, the hydrogenation may include reducing the diamine-monoboranes of the invention with a source of hydride. The hydride typically formally adds to the ring boron atom. When used in combination, the compound may first be hydrogenated to yield a saturated intermediate, and the saturated intermediate then reacts with hydride.

The hydrogen storage system may include at least one of the compounds described above. Where the disclosed compounds are used in a hydrogen storage system, in one embodiment the compounds may be present in a liquid phase, such as dissolved in a suitable organic solvent. In other embodiments, the compounds are present in a liquid phase, but not dissolved in an organic solvent. The hydrogen storage device and/or liquid phase may include one or more catalysts, solvents, salts, clathrates, crown ethers, carcarands, acids, and bases. The hydrogen storage system may include a port for the introduction of hydrogen for subsequent storage. Similarly, it may include a tap or port for the collection of released hydrogen gas.

Such a hydrogen storage system may be incorporated into a portable power cell, or may be installed in conjunction with a hydrogen-burning engine. The hydrogen storage system may be used in or with a hydrogen-powered vehicle, such as an automobile. Alternatively, the hydrogen storage device may be installed in or near a residence, as part of a single-home or multi-home hydrogen-based power generation system. Larger versions of the hydrogen storage device may be used in conjunction with, or in replacements for, conventional power generating stations. Other uses relate to transport down pipelines and in tankers.

The hydrogen storage system may also utilize one or more additional methods of hydrogen storage in combination with the presently disclosed compounds, including storage via compressed hydrogen, liquid hydrogen, and/or slush hydrogen. Alternatively, or in addition, the hydrogen storage system may include alternative methods of chemical storage, such as via metal hydrides, carbohydrates, ammonia, amine borane complexes, formic acid, ionic liquids, phosphonium borate, or carbonite substances, among others. Alternatively, or in addition, the hydrogen storage system may include methods of physical storage, such as via carbon nanotubes, metal-organic frameworks, clathrate hydrates, doped polymers, glass capillary arrays, glass microspheres, or keratine, among others.

In certain embodiments, at least one of the compounds disclosed herein may be included as an additive in a liquid composition that includes at least one further additive in addition to the compound(s) disclosed herein. Preferably, the composition is a liquid at a temperature of 20° C. at 1 atmosphere. In other embodiments, the composition is a liquid at a temperature of −20° C. to 50° C., more particularly −15° C. to 40° C., at 1 atmosphere.

An illustrative liquid composition includes at least one compound disclosed herein and at least further fuel additive, particularly a further H₂ fuel additive. For example, the composition may be a fuel blend that includes the compound disclosed herein as a solvent for a higher H₂-capacity fuel additive (e.g., ammonia borane). In such an embodiment, certain embodiments of the presently disclosed compound have a relatively high boiling point due to their polar zwitterionic nature. Such compounds can serve as an ionic liquid solvent for polar hydrogen storage compounds such as ammonia borane (NH₃—BH₃, 19.6 wt %), methylamine borane (MeNH₂—BH₃), or R²⁰NH₂—BH₂R²¹ wherein R²⁰ and R²¹ are each individually a C₁-C₆ alkyl. Consequently, the liquid fuel composition may exceed 10 wt % H while maintaining a liquid phase.

The present invention provides a hydrogen storage system comprising a compound of Formula I, III or IV. Preferably the hydrogen storage system further comprises a structure configured to hold the compound of Formula I, III or IV.

The present invention provides a method comprising releasing hydrogen from the compound of Formula I, III or IV. Preferably, releasing hydrogen comprises releasing one or more equivalents of dihydrogen from any one of the compounds of Formula I, III or IV. Preferably releasing hydrogen comprises producing a 1,3,2-diazaborolidine (cyclic diaminoborane). The method further comprises the step of hydrogenating the 1,3,2-diazaborolidine (cyclic diaminoborane).

The present invention also provides use of the compositions of the invention in a fuel cell. The present invention further provides use of compounds of the invention in a fuel cell or a portable power cell, or cell installed in conjunction with a hydrogen-burning engine, or in transport down pipelines, or for transport in tankers. The present invention further provides a fuel cell, portable power cell, or cell installed in conjunction with a hydrogen-burning engine comprising a compound of the invention.

The skilled addressee will understand that the invention comprises the embodiments and features disclosed herein as well as all combinations and/or permeations of the disclosed embodiments and features.

### BRIEF DESCRIPTION OF THE DRAWINGS

Preferred embodiments of the invention will now be described, by way of example only, with reference to the accompanying drawings.

FIG. 1 is a ¹H NMR of the ethylenediamine mono-borane of the invention; and

FIG. 2 is an ¹¹B NMR of ethylenediamine mono-borane.

FIG. 3 shows the crystal structure of ethylenediamine monoborane determined by X-ray single crystal diffraction analysis: a) molecular packing in a unit cell; b) one single molecule. Atom key: large black—boron; dark grey—carbon; small black—nitrogen; light grey—hydrogen.

### DEFINITIONS

In describing and claiming the present invention, the following terminology has been used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising”, and the like are to be construed in an inclusive sense as opposed to an exclusive or exhaustive sense; that is to say, in the sense of ‘including, but not limited to’.

The terms ‘preferred’ and ‘preferably’ refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

Other than in the operating examples, or where otherwise indicated, all numbers expressing quantities of ingredients or reaction conditions used herein are to be understood as modified in all instances by the term ‘about’.

The recitation of a numerical range using endpoints includes all numbers subsumed within that range (e.g., 1 to 5 includes 1, 1.5, 2, 2.75, 3, 3.80, 4, 5, etc.).

The term “alkyl” means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl, etc.

Unless otherwise specified a substituted or unsubstituted alkyl group is preferably a C₁ to C₆-alkyl group.

“Acyl” refers to a group having the structure R(O)C—, where R may be alkyl, or substituted alkyl. “Lower acyl” groups are those that contain one to six carbon atoms.

The term “substituted”, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms.

The term “alkoxy” refers to a straight, branched or cyclic hydrocarbon configuration that include an oxygen atom at the point of attachment. An example of an “alkoxy group” is represented by the formula —OR, where R can be an alkyl group. Suitable alkoxy groups include methoxy, ethoxy, n-propoxy, i-propoxy, n-butoxy, i-butoxy, sec-butoxy, tert-butoxy cyclopropoxy, cyclohexyloxy, and the like.

Unless otherwise specified a substituted alkyl group, a substituted cycloalkyl group, a substituted aryl group and a substituted alkoxy group are preferably substituted by one or more constituents selected from the group consisting of methyl, ethyl, n-propyl, isopropyl, n-butyl, isobutyl and tertiary-butyl, ester group, amide group, ether group, thioether group, ketone group, aldehyde group, sulfoxide group, sulfone group, sulfonate ester group, sulphonamide group, —Cl, —Br, —I, —OH, —SH, —CN and —NO₂.

The term “halogen” refers to fluoro, bromo, chloro and iodo substituents.

The term “amino”, unless defined otherwise, refers to a group of the formula —NRR′, where R and R′ can be, each independently, hydrogen or a C₁-C₆ alkyl.

The term “carbocyclylalkyl”, as used herein, refers to an alkyl group substituted with a carbocycle group.

The terms “carbocycle” and “carbocyclyl”, as used herein, refer to a non-aromatic saturated or unsaturated ring in which each atom of the ring is carbon. Preferably a carbocycle ring contains from 3 to 10 atoms, more preferably from 5 to 7 atoms.

The prior art referred to in this specification is incorporated herein by reference.

### PREFERRED EMBODIMENT OF THE INVENTION

The present invention will now be described with reference to the following examples which should be considered in all respects as illustrative and non-restrictive.

### Synthesis of Ethylenediamine Mono-Borane

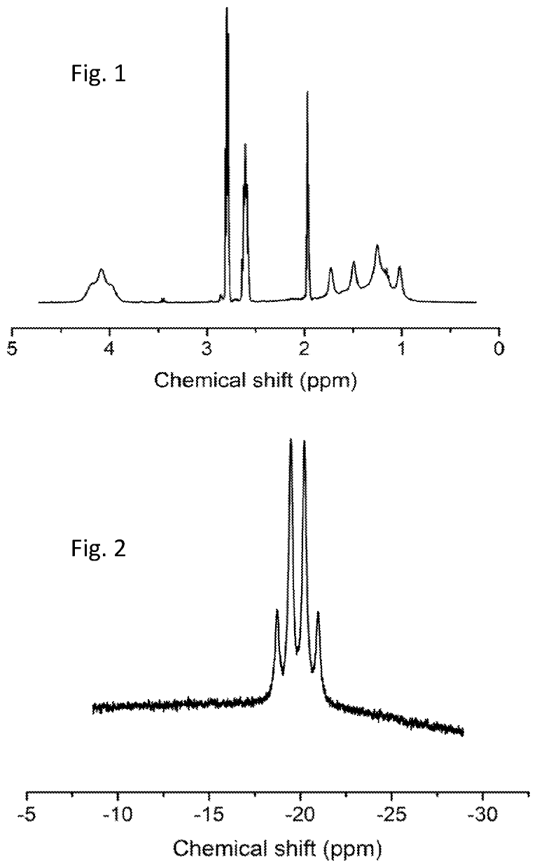

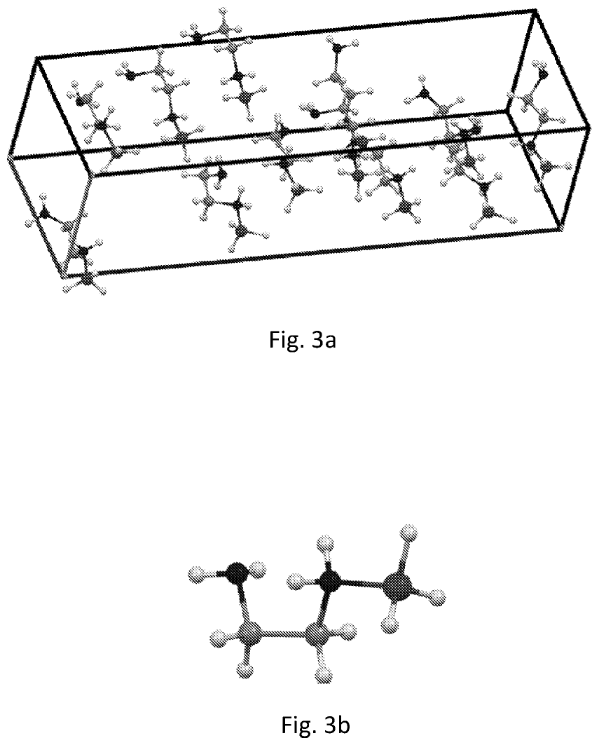

A dry vial was charged with 1 eq ethylenediamine and then placed into an ice-bath. The compound BH₃.THF (1eq) was added slowly via syringe. The reaction solution was left to stir at room temperature for 24 hours. THF was removed by evaporation at reduced pressure and the resultant oily liquid was thrice washed using hexanes. The mixture then was dissolved in chloroform. The product was analysed by ¹H NMR and ¹¹B NMR spectra (FIG. 1. and FIG. 2, respectively). A crystal structure of the resultant product is shown in FIG. 3.

### Dehydrogenation Reaction

Dehydrogenation experiments were undertaken using commercially available catalysts, such as Pd/C, and the purity of the evolved hydrogen gas was determined via mass spectrometer and gas chromatography. When 1 wt. % Pd/C was added to the liquid ethylenediamine mono-borane of the invention, only dihydrogen molecules were detected being released from the liquid. High purity H₂ was released from the liquid at temperatures below 100° C. (at 50° C.) with fast kinetics, which is highly compatible with standard hydrogen fuel cell. The hydrogen capacity of the ethylenediamine mono-borane of the invention is 5 wt %, making it an ideal candidate for long distance, large scale energy storage and delivery via the well-established fuel transportation infrastructure.

The novel compounds of the present invention possess properties which make them suitable candidates to meet at least some of the following requirements: good hydrogen-storage efficiency and capacity relative to the weight of the material; good absorption/desorption rate; good dissociation equilibrium pressure; suitable desorption temperature/pressure; good repeated absorption-desorption cycles without significant loss of its hydrogen storage capabilities (i.e. reversibility); good hydrogenation/dehydrogenation kinetics to enable hydrogen to be absorbed or desorbed in a relatively short period of time; good resistance to poisoning by contaminants to which the material may be subjected during manufacturing and utilization; little or no hysteresis issues; no phase change upon H₂ desorption; a liquid under ambient conditions (e.g., at 20° C. and 1 atm pressure); and good air stability; complete or almost complete release of H₂ over a wide variety of commercial catalysts.

Although the invention has been described with reference to specific examples, it will be appreciated by those skilled in the art that the invention may be embodied in many other forms. In particular features of any one of the various described examples may be provided in any combination in any of the other described examples.

1. A compound having a structure represented by Formula III: 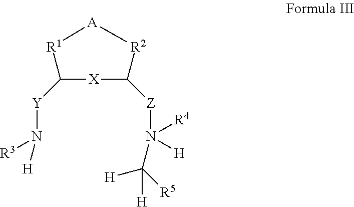
wherein A is optional,
if the A is not present, each of R¹ and R² is individually selected from H, OH, C₁-C₆ alkyl, substituted C₁-C₆ alkyl, C₃₋₈ cycloalkyl, substituted C₃₋₈ cycloalkyl, C₁-C₆ alkoxy, substituted C₁-C₆ alkoxy, amino with a structure NR⁶R⁷, cyano with a structure CN, carbocyclylalkyl with a structure including —(CH₂)ₙ-Ph in which n=0-6, halogen, C₆₋₁₀ aryl, or substituted C₆₋₁₀ aryl, or
if the A is present, the A is selected from —(CH₂)ₙ— in which n=1-6, —O—, —C(═O)—, —S—, —S(═O)—, or —CHR⁸—, and each of R¹ and R² is individually selected from bridging C₁-C₆ alkyl, bridging substituted C₁-C₆ alkyl, bridging C₁-C₆ alkoxy, bridging substituted C₁-C₆ alkoxy, bridging amino with a structure NR⁶, bridging C₆₋₁₀ aryl, or bridging substituted C₆₋₁₀ aryl;
wherein each of R³ and R⁴ is individually selected from H, OH, a C₁-C₆ alkyl, cycloalkyl, haloalkyl, C₁-C₆ acyl, NH₂, CN, or SiR⁹;
wherein R⁵ is selected from H, C₁-C₆ alkyl, NH₂, CN, or OH;
wherein each of R⁶ and R⁷ is independently selected from H, C₁-C₆ alkyl, or substituted C₁-C₆ alkyl;
wherein R⁸ is selected from C₁-C₆ alkyl, halogen, C₁-C₆ alkoxy, C₁-C₆ alkoxy-substituted C₁-C₆ alkyl, or amino with a structure NR⁶R⁷;
wherein R⁹ is selected from halogen, amino with a structure NR⁶R⁷, alkoxy, or —(CH₂)ₙ-Ph in which n=0-6, and
wherein each of X, Y and Z is independently selected from —(CH₂)ₙ— in which n=0-6, —O—, —C(═O)—, —S—, —S(═O)—, or —CHR⁸—.

2. (canceled)

3. (canceled)

4. The compound of claim 1, having a structure represented by Formula IV: 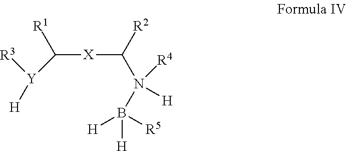
wherein each of R¹ and R² is individually selected from H, OH, C₁-C₆ alkyl, substituted C₁-C₆ alkyl, C₃₋₈ cycloalkyl, substituted C₃₋₈ cycloalkyl, C₁-C₆ alkoxy, substituted C₁-C₆ alkoxy, amino with a structure NR⁶R⁷, cyano with a structure CN, carbocyclylalkyl with a structure including —(CH₂)ₙ-Ph in which n=0-6, halogen, C₆₋₁₀ aryl, or substituted C₆₋₁₀ aryl;
wherein each of R³ and R⁴ is individually selected from H, OH, C₁-C₆ alkyl, cycloalkyl, haloalkyl, C₁-C₆ acyl, NH₂, CN, or SiR⁹;
wherein R⁵ is selected from H, C₁-C₆ alkyl, NH₂, CN, or OH;
wherein each of R⁶ and R⁷ is independently selected from H, C₁-C₆ alkyl, or substituted C₁-C₆ alkyl;
wherein R⁸ is selected from C₁-C₆ alkyl, halogen, C₁-C₆ alkoxy, C₁-C₆ alkoxy-substituted C₁-C₆ alkyl, or amino with a structure NR⁶R⁷;
wherein R⁹ is selected from halogen, amino, alkoxy, or —(CH₂)ₙ-Ph in which n=0-6; and
wherein X is selected from —(CH₂)ₙ— in which n=0-6, —O—, —C(═O)—, —S—, —S(═O)—, or —CHR⁸—.

5. (canceled)

6. The compound of claim 1, wherein at least one of:
each of the R¹ and the R² is individually selected from methyl or ethyl, and each of the R³ and the R⁴ is individually selected from methyl or ethyl.

7. (canceled)

8. The compound of claim 1, having a structure represented by Formula I: 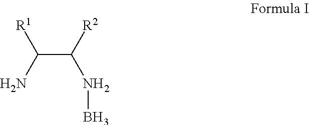
wherein each of R¹ and R² is individually selected from H, C1-C6 alkyl, C1-C6 alkoxy, NH2, cyano with a structure CN, or halogen.

9. The compound of claim 1, having a structure represented by Formula I, 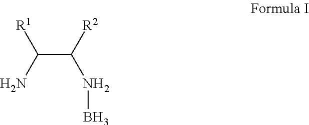
wherein R¹ and R² are both H.

10. (canceled)

11. (canceled)

12. The compound of claim 1, wherein the compound is a liquid at 20° C. and 1 atmosphere.

13. The compound of claim 1 wherein the compound has a hydrogen capacity at a gravimetric density of between about 3.0 and 6.0 wt % or a volumetric density of at least 35 g H₂/L.

14. (canceled)

15. (canceled)

16. (canceled)

17. (canceled)

18. (canceled)

19. (canceled)

20. A method of preparing a diamine-monoborane compound, the method comprising the steps of:
reacting a compound having a structure represented by Formula VI with at least one of BH₃, B₂H₆, BH₃.THF, BH₃.SMe₂, and disiamylborane to obtain the compound having the structure represented by the Formula III according to claim 1, 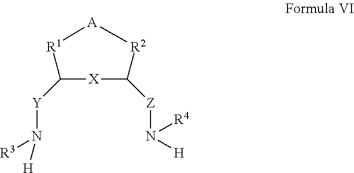
wherein A is optional,
if the A is not present, each of R¹ and R² is individually selected from H, OH, C₁-C₆ alkyl, substituted C₁-C₆ alkyl, C₃₋₈ cycloalkyl, substituted C₃₋₈ cycloalkyl, C₁-C₆ alkoxy, substituted C₁-C₆ alkoxy, amino with a structure NR⁶R⁷, cyano with a structure CN, carbocyclylalkyl with a structure including —(CH₂)ₙ-Ph in which n=0-6, halogen, C₆₋₁₀ aryl, or substituted C₆₋₁₀ aryl; or
if the A is present, the A is selected from —(CH₂)ₙ— in which n=1-6, —O—, —C(═O)—, —S—, —S(═O)—, or —CHR⁸—, and each of R¹ and R² is individually selected from bridging C₁-C₆ alkyl, bridging substituted C₁-C₆ alkyl, bridging C₁-C₆ alkoxy, bridging substituted C₁-C₆ alkoxy, bridging amino with a structure NR⁶, bridging C₆₋₁₀ aryl, or bridging substituted C₆₋₁₀ aryl; and
wherein each of R³ and R⁴ is individually selected from H, OH, a C₁-C₆ alkyl, cycloalkyl, haloalkyl, C₁-C₆ acyl, NH₂, CN, or SiR⁹;
wherein each of R⁶ and R⁷ is independently selected from H, C₁-C₆ alkyl, or substituted C₁-C₆ alkyl;
wherein R⁸ is selected from C₁-C₆ alkyl, halogen, C₁-C₆ alkoxy, C₁-C₆ alkoxy-substituted C₁-C₆ alkyl, or amino with a structure NR⁶R⁷;
wherein R⁹ is selected from halogen, amino with a structure NR⁶R⁷, alkoxy, or —(CH₂)ₙ-Ph in which n=0-6; and
wherein each of X, Y and Z is independently selected from —(CH₂)ₙ— in which n=0-6, —O—, —C(═O)—, —S—, —S(═O)—, or —CHR⁸—.

21. (canceled)

22. (canceled)

23. The method of claim 20, wherein the reaction is conducted at room temperature for 24 hours.

24. A method for reversibly storing and releasing hydrogen, the method comprising the steps of:
a) providing a diamine-monoborane compound having a structure represented by Formula III which is capable of reversible dehydrogenation and hydrogenation;
b) contacting the diamine-monoborane compound under reaction conditions sufficient to release gaseous hydrogen from the diamine-monoborane compound and produce at least partially dehydrogenated 1,3,2-diazaborolidine; and
c) recovering the gaseous hydrogen,
wherein Formula III has the structure: 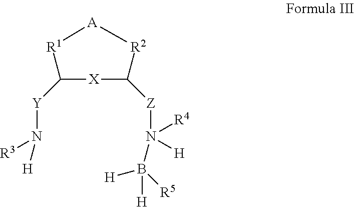
wherein A is optional,
if the A is not present, each of R¹ and R² is individually selected from H, OH, C₁-C₆ alkyl, substituted C₁-C₆ alkyl, C₃₋₈ cycloalkyl, substituted C₃₋₈ cycloalkyl, C₁-C₆ alkoxy, substituted C₁-C₆ alkoxy, amino with a structure NR⁶R⁷, cyano with a structure CN, carbocyclylalkyl with a structure including —(CH₂)ₙ-Ph in which n=0-6, halogen, C₆₋₁₀ aryl, or substituted C₆₋₁₀ aryl; or
if the A is present, the A is selected from —(CH₂)ₙ— in which n=1-6, —O—, —C(═O)—, —S—, —S(═O)—, or —CHR⁸—, and each of R¹ and R² is individually selected from bridging C₁-C₆ alkyl, bridging substituted C₁-C₆ alkyl, bridging C₁-C₆ alkoxy, bridging substituted C₁-C₆ alkoxy, bridging amino with a structure NR⁶, bridging C₆₋₁₀ aryl, or bridging substituted C₆₋₁₀ aryl; and
wherein each of R³ and R⁴ is individually selected from H, OH, a C₁-C₆ alkyl, cycloalkyl, haloalkyl, C₁-C₆ acyl, NH₂, CN, or SiR⁹;
wherein R⁵ is selected from H, C₁-C₆ alkyl, NH₂, CN, or OH;
wherein each of R⁶ and R⁷ is independently selected from H, C₁-C₆ alkyl, or substituted C₁-C₆ alkyl;
wherein R⁸ is selected from C₁-C₆ alkyl, halogen, C₁-C₆ alkoxy, C₁-C₆ alkoxy-substituted C₁-C₆ alkyl, or amino with a structure NR⁶R⁷;
wherein R⁹ is selected from halogen, amino with a structure NR⁶R⁷, alkoxy, or —(CH₂)ₙ-Ph in which n=0-6; and
wherein each of X, Y and Z is independently selected from —(CH₂)ₙ— in which n=0-6, —O—, —C(═O)—, —S—, —S(═O)—, or —CHR⁸—.

25. The method of claim 24, further comprising the steps of:
d) contacting the at least partially dehydrogenated 1,3,2-diazaborolidine under conditions to hydrogenate the dehydrogenated 1,3,2-diazaborolidine to produce a diamine-monoborane compound having a structure represented by the Formula III, and
e) recovering the produced diamine-monoborane compound having the structure represented by the Formula III.

26. The method of claim 24, wherein the step b) reaction conditions include heating the diamine-monoborane compound at a temperature from 20 to 150° C. to affect release of at least one dihydrogen equivalent.

27. (canceled)

28. The method of claim 24, wherein the step b) reaction conditions include a catalytic reaction to absorb or release hydrogen, the catalytic reaction comprising contacting the diamine-monoborane compound with a catalyst at a temperature from about 20 to 200° C.

29. (canceled)

30. The method of claim 28, wherein the catalyst is at least one of:
a metal halide catalyst selected from CoCl₂, CuCl₂, NiCl₂, FeCl₃ and FeCl₂,
a catalyst comprising one or more platinum group metals selected from the group consisting of: platinum, palladium, rhodium, ruthenium, and iridium, and
a catalyst comprising nickel.

31. (canceled)

32. The method of claim 28, wherein the catalyst is [RuH₂(η²-H₂)₂(PCy₃)₂].

33. The method of claim 24, wherein the dehydrogenated 1,3,2-diazaborolidine has a structure represented by Formula V:

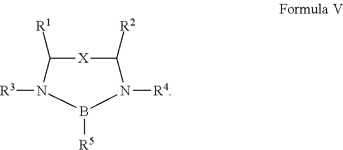

34. The method of claim 24, wherein the dehydrogenated 1,3,2-diazaborolidine is a liquid at 20° C. and 1 atmosphere, and remains in the liquid phase until being hydrogenated in step d).

35. (canceled)

36. The method of claim 24, wherein at least one of:
each of the R¹ and the R² is individually selected from methyl or ethyl, and
each of the R³ and the R⁴ is individually selected from methyl or ethyl.

37. The method of claim 24, wherein the diamine-monoborane compound in step a) has a structure represented by Formula I: 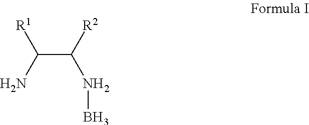
wherein each of R¹ and R² are individually selected from H, C₁-C₆ alkyl, C₁-C₆ alkoxy, NH₂, cyano with a structure CN, or halogen.

38. The method of claim 37, wherein the R¹ and the R² are both H.
